(19) United States
(12) Patent Application Publication
(10) Pub. No.: US 2014/0067333 A1
(43) Pub. Date: Mar. 6, 2014

(54) CAD-Based System for Product Definition, Inspection and Validation

(71) Applicants: David Rodney, Simsbury, CT (US); Jordan David Ryskamp, Spanish Fork, UT (US)

(72) Inventors: David Rodney, Simsbury, CT (US); Jordan David Ryskamp, Spanish Fork, UT (US)

(73) Assignee: BELCAN CORPORATION, Cincinnati, OH (US)

(21) Appl. No.: 13/602,569

(22) Filed: Sep. 4, 2012

(51) Int. Cl. G06F 17/50

(52) U.S. Cl. 703/1

(57) ABSTRACT

Various embodiments pertain to techniques for displaying and interacting with two-dimensional (2-D) drawing views in a three-dimensional (3-D) modeling environment within a computer-aided design (CAD) system. In various embodiments, the application programmable interface (API) of the CAD system is configured to enable 2-D drawing views to be displayed in the CAD system's 3-D modeling environment. The drawing views are assembled and oriented in 3-D space relative to one another and in relation to a 3-D model of the object that they define. In various embodiments, the drawing views can be projected onto surfaces bounding a volume that contains or confines a 3-D model of the object. Those surfaces may be corresponding planar faces of a cube or other polyhedron that contains or confines a 3-D model of the object.

### BACKGROUND

Product quality is a key to maintaining a manufacturing enterprise's competitive ability. As manufactured products become increasingly complex, the burden of verifying the correctness and accuracy of components of assembled products grows correspondingly. Many enterprises perform verification by utilizing a variety of manual tasks and non-standardized test programs. A slower verification rate results in a slower output, and can affect the accuracy and consistency of the quality control process. However, as computer performance improves, some manufacturing enterprises utilize computer systems in at least some part of the verification process.

Some engineering and manufacturing operations frequently utilize scanning equipment capable of gathering high resolution point cloud representations of parts and assemblies. While point cloud data can be topologically accurate, it is not geometric. In other words, boundaries between features in a point cloud are indistinct and ambiguous. Point cloud data corresponding to an as-manufactured part can be collected for comparison to engineering drawings, or nominal two-dimensional (2-D) computer-aided design (CAD) geometries, to determine where deviations have occurred. This can be useful, for example, in inspecting parts before they are assembled and other quality assurance processes. However, comparing point cloud data to CAD geometry, such as for dimensional inspection purposes, is difficult, time-consuming, and error prone.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments pertain to techniques for displaying and interacting with two-dimensional (2-D) drawings in a three-dimensional (3-D) environment (e.g., a modeling environment) within a computer-aided design (CAD) system. In various embodiments, an application programmable interface (API) of the CAD system is configured to enable 2-D drawing views to be displayed the 3-D modeling environment. The drawing views are assembled in 3-D space relative to one another and in relation to a 3-D model of the object that they define. In various embodiments, the drawing view(s) are placed around the 3-D model so as to provide dimensionality to strategic regions of interest. These views can be projected onto a plane, a surface, a midplane, or subsurface without restriction in any manner so as to best provide dimensionality to the 3-D model. For example, in some embodiments, the drawing views are projected onto a corresponding plane of a cube, and the cube contains or confines the 3-D model of the part. In such embodiments, a corresponding plane of the cube can be a face of the cube (e.g., a front face, rear face, top face, etc.) or can be an internal plane of the cube.

In various embodiments, point cloud data representing the surface topology of a manufactured object is also imported into the modeling environment and aligned with corresponding CAD geometry. This enables a direct visual and dimensional comparison of a manufactured object with corresponding nominal 3-D geometry and 2-D drawing views in the CAD system without causing dimensions, tolerances and notations to be recreated.

### BRIEF DESCRIPTION OF THE DRAWINGS

While the specification concludes with claims particularly pointing out and distinctly claiming the subject matter, it is believed that the embodiments will be better understood from the following description in conjunction with the accompanying figures, in which:

FIG. 1 is an illustration of an environment in an example implementation in accordance with one or more embodiments;

FIG. 2 is a block diagram of a CAD executable module in accordance with one or more embodiments;

FIG. 3A illustrates an example 2-D CAD environment, or drafting environment, in accordance with one or more embodiments;

FIG. 3B illustrates an example 3-D CAD environment, or modeling environment, in accordance with one or more embodiments;

FIG. 4 depicts example drawing views in an example modeling environment in accordance with one or more embodiments;

FIG. 5 illustrates example drawing views in an example modeling environment in accordance with one or more embodiments;

FIG. 6 is a flow diagram of an example method in accordance with one or more embodiments;

FIG. 7 is a flow diagram of another example method in accordance with one or more embodiments; and

FIG. 8 is an illustration of an example device that can be used to implement one or more embodiments.

### DETAILED DESCRIPTION

### Overview

Various embodiments pertain to techniques for displaying and interacting with two-dimensional (2-D) drawings in a three-dimensional (3-D) environment (e.g., a modeling environment) within a computer-aided design (CAD) system. In various embodiments, an application programmable interface (API) of the CAD system is configured to enable 2-D drawing views to be displayed the 3-D modeling environment. The drawing views are assembled in 3-D space relative to one another and in relation to a 3-D model of the object that they define. In various embodiments, the drawing view(s) are placed around the 3-D model so as to provide dimensionality to strategic regions of interest. These views can be projected onto a plane, a surface, a midplane, or subsurface without restriction in any manner so as to best provide dimensionality to the 3-D model. For example, in some embodiments, the drawing views are projected onto a corresponding plane of a cube, and the cube contains or confines the 3-D model of the part. In such embodiments, a corresponding plane of the cube can be a face of the cube (e.g., a front face, rear face, top face, etc.) or can be an internal plane of the cube.

In various embodiments, point cloud data from a scan of a manufactured object is also imported into the modeling environment and aligned with the CAD geometry. The point cloud data can enable a direct visual and dimensional comparison of the surface topology of the manufactured object and corresponding nominal 3-D geometry and 2-D drawing views in the drawing view assembly without causing dimensions, tolerances and notations to be recreated.

In the discussion that follows, a section entitled “Example Operating Environment” describes an operating environment in accordance with one or more embodiments. Next, a section entitled “Example Embodiments” describes various techniques for combining interacting with drawing views in a modeling environment within a computer-aided design (CAD) system. Finally, a section entitled “Example Device” describes a device that can be used to implement one or more embodiments.

Consider, now, an example operating environment in accordance with one or more embodiments.

### Example Operating Environment

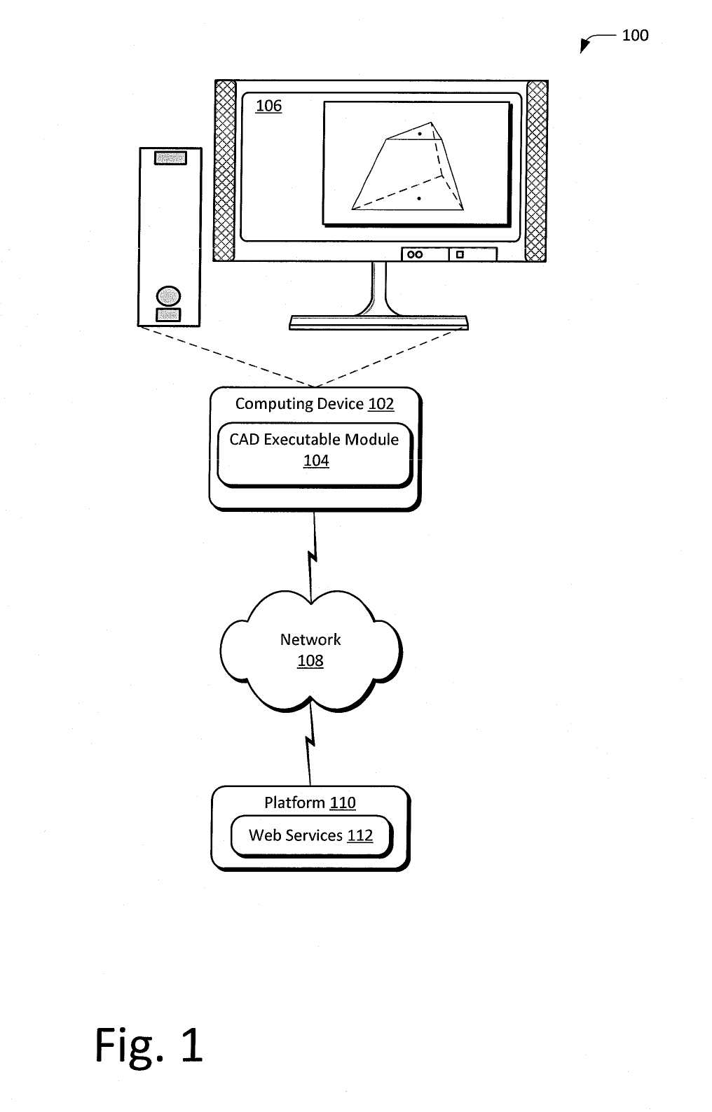

FIG. 1 is an illustration of an environment 100 in an example implementation that is operable to employ the modeling techniques described in this document. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 includes a CAD executable module 104 configured to enable a user to create, modify, or analyze a design. For example, CAD executable module 104 can enable a user, such as a mechanical engineer, to create a technical drawing of a part to be manufactured. CAD executable module 104 also enables the user to convey information, such as materials, processes, dimension, and tolerances related to the design.

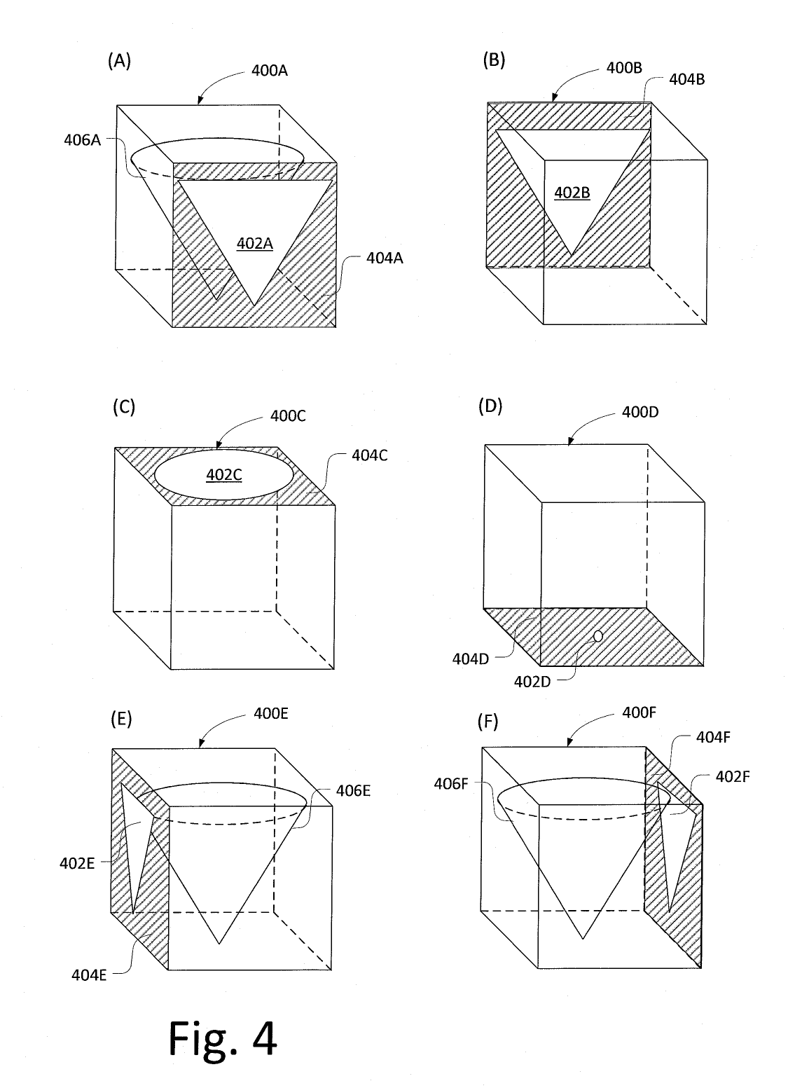

CAD executable module 104 is representative of functionality that enables a user to create, modify or analyze a design shown on a display 106 in two or three dimensions. For example, a user can create drafting illustrations of a particular part in a 2-D drafting environment and can view a 3-D model of the part in a 3-D modeling environment. In various embodiments, CAD executable module 104 is configured such that drawing views created in the 2-D drafting environment can be viewed in the 3-D modeling environment along with a 3-D model of the part. In particular, CAD executable module 104 is configured to enable 2-D drawing views to be associated with a corresponding surface in the 3-D modeling environment. Such surfaces are configured to contain or confine the 3-D model of the part. The drawing views are associated with a bounding surface in an orientation consistent with the 3-D model and the relations between the drawing views, as will be further described in association with FIG. 4.

Computing device 102 is communicatively coupled to network 106. Network 106 is illustrated as being communicatively coupled to a platform 110 for web services 112. The platform 110 abstracts underlying functionality of hardware (e.g., servers) and software resources of the network 108 and thus may act as a “cloud operating system.” For example, the platform 110 may abstract resources to connect the computing device 102 with other computing devices. The platform 110 may also serve to abstract scaling of resources to provide a corresponding level of scale to encountered demand for the web services 112 that are implemented via the platform 110. A variety of other examples are also contemplated, such as load balancing of servers in a server farm, protection against malicious parties (e.g., spam, viruses, and other malware), and so on.

Thus, the network 108 is included as a part of the strategy that pertains to software and hardware resources that are made available to the computing device 102 via the Internet or other networks. For example, the CAD executable module 104 may be implemented in part on the computing device 102 as well as via a platform 110 that supports web services 112.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile and computer uses. The computing device 102 can also be configured in other ways for other uses.

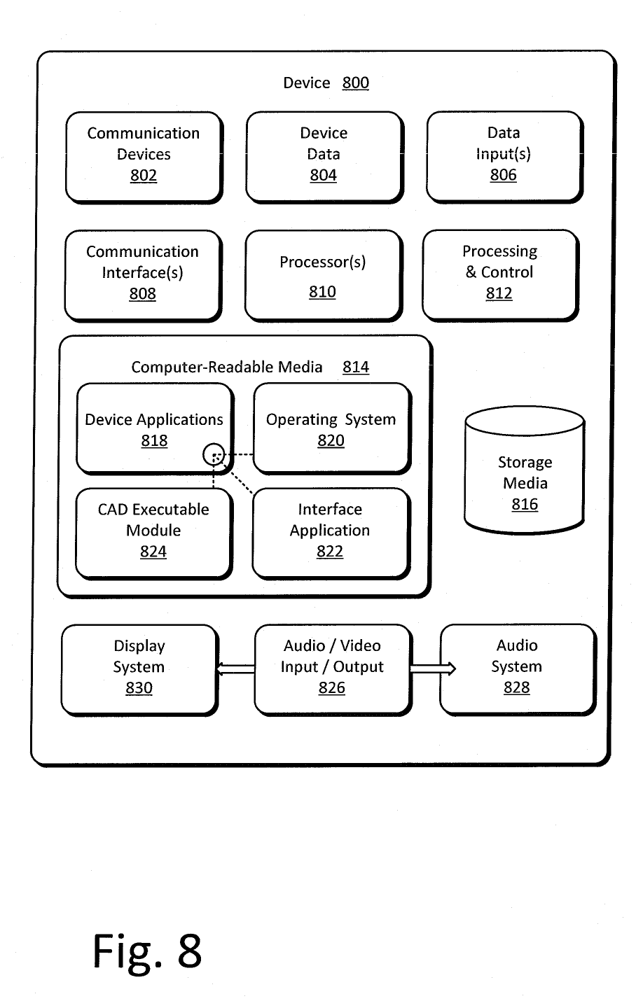

The computer-readable storage media included in each device or server can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 8.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer-readable memory devices. The features of the user interface techniques described below are platform-independent, meaning that the techniques may be implemented on a variety of commercial computing platforms having a variety of processors.

Having described an example environment, consider now a discussion of techniques for displaying and interacting with 2-D drawings in a 3-D environment within a CAD system.

### Example Embodiments

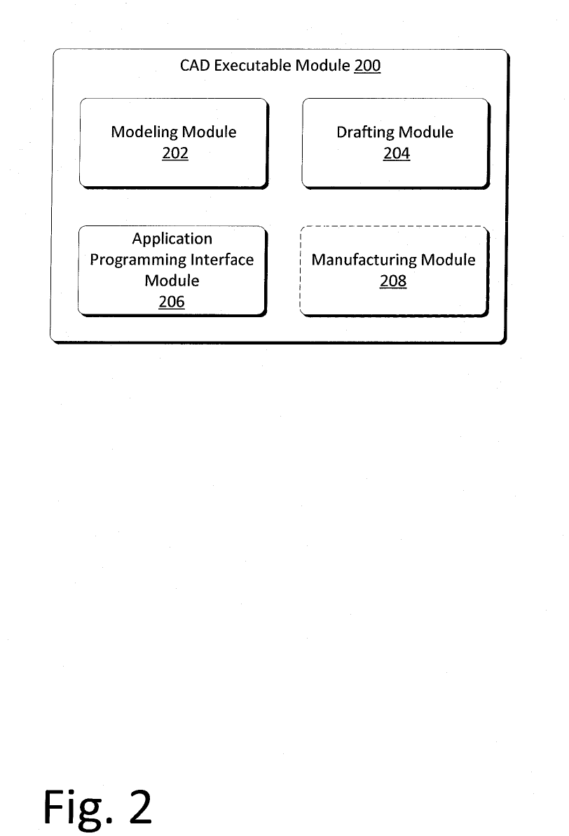

FIG. 2 is a block diagram depicting a CAD executable module 200 in accordance with one or more embodiments. In FIG. 2, CAD executable module 200 includes a modeling module 202, a drafting module 204, and an application programming interface module 206.

Modeling module 202 is configured to provide a 3-D modeling environment for use in computer-aided design. In particular, modeling module 202 is configured to create mathematical representations, or 3-D models, of various 3-D surfaces of an object from user input, scan data, another method, or some combination thereof. In some embodiments, modeling module 202 is configured to develop and/or display solid 3-D models, although in other embodiments, shell or boundary models can be used.

In various embodiments, 2-D sketches, or drawing views, can be extracted or generated from the 3-D model of an object by drafting module 204. Drafting module 204 is configured to generate a 2-D drafting environment for use in computer-aided design. In particular, drafting module 204 is configured to create 2-D representations, or drawing views, of an object. The drawing views can include orthographic, projected or section views, and in various embodiments, can also include annotations, such as comments regarding materials to be used, tolerances, and other notations. Each drawing view can be extracted from a 3-D model of the object or can be generated in the drafting environment. In various embodiments, drawing views extracted from a 3-D model can be modified by a user. In some embodiments, modifying a drawing view can sever a link between the drawing view and the 3-D model, while in other embodiments, modifying the drawing view can result in automatically modifying the linked 3-D model based on the modifications to the drawing view.

In addition to modeling module 202 and drafting module 204, CAD executable module 200 includes an application programming interface module 206. In various embodiments, application programming interface module 206 is configured to enable a user to automate tasks, customize files, and otherwise manipulate the CAD executable module and associated files programmatically. Application programming interface module 206, in various embodiments, can enable a user to “reach across” the divide between the modeling environment and the drafting environment and interact with drawing views in the modeling environment.

In some embodiments, CAD executable module 200 also includes an optional manufacturing module 208. Manufacturing module 208 is configured to create one or more stereolithography (STL) files that describe the surface geometry of a 3-D object. The STL file can correspond to a faceted surface representation of a point cloud. The point cloud can be, for example, obtained by optically scanning the 3-D object with a scanner. Manufacturing module 208 creates an STL file for the point cloud and a user can import the file into the CAD environment. STL files can be in another file format such as PLY, DXF, VRML, or the like, depending on the particular embodiment. As used herein, STL files are representative of any file that may be used to translate point cloud data into a format for use within the CAD executable module. In various embodiments, the manufacturing module 208, working together with the modeling module 202, the drafting module 204 and the API module 206, can enable a user to perform real-time, in-process part inspection during a manufacturing process and adjust the manufacturing process responsive to the inspection.

Having described an example CAD executable module, consider now the following discussion of various embodiments that can be implemented by the CAD executable module.

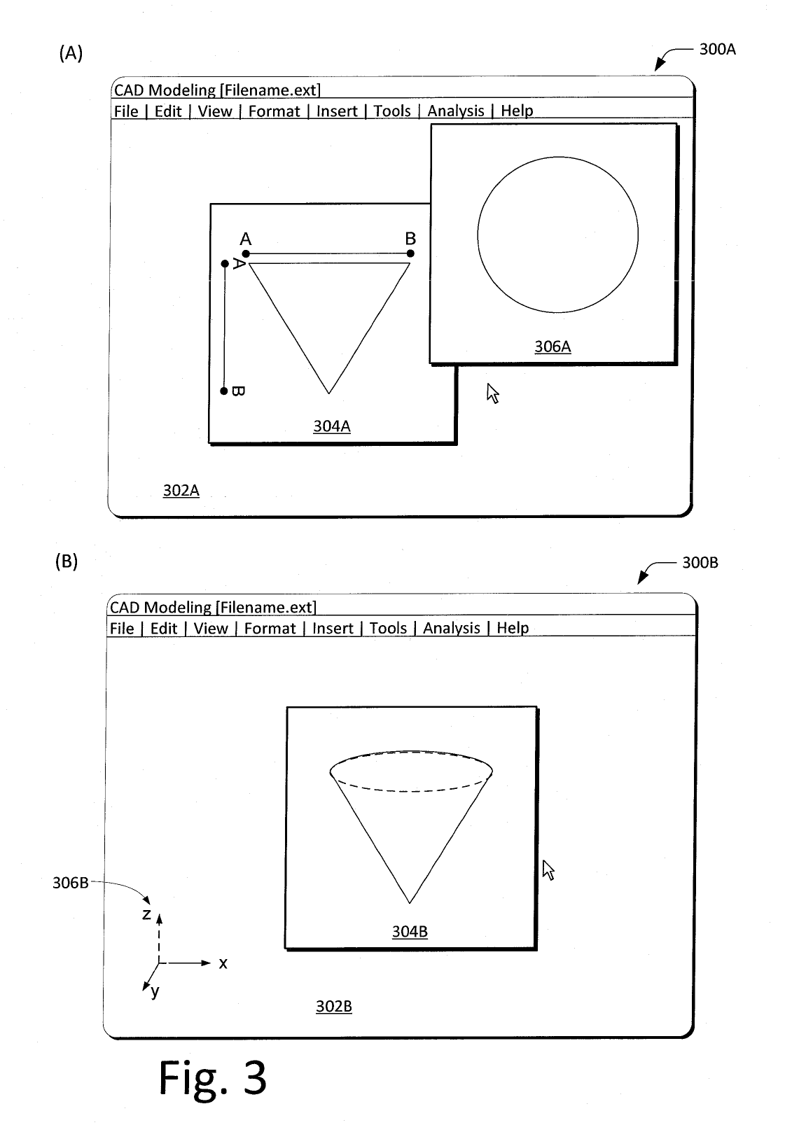

FIG. 3A illustrates an example drafting environment 300A (e.g., 2-D drawing environment) in accordance with one or more embodiments. The drafting environment 300A is represented by a user interface 302A. Within user interface 302A, various views 304A and 306A are shown. View 304A can be, for example, a first view of a part to be manufactured, while view 306A can be a second view of the part. In particular, in the embodiment shown in FIG. 3A, view 304A is a side view of a part having a conical shape, while view 306A is a top view of the part. Additional or alternative views can be included, depending on the specific embodiment. For example, in some embodiments, different views of the left and right sides, front and back, and bottom can be included. In some embodiments, views can represent a section of the part (e.g., a 2-D slice through the 3-D model) or a projection onto a 2-D surface in any orientation around the part.

Each drawing view can include one or more sets of data. The sets of data can include design information, spatial information or parametric data, such as drawing dimensions, tolerances, notes, and other data corresponding to the part or object. For example, in FIG. 3A, view 304A includes various dimensions represented by the lines A-B. Other measurements can be included, depending on the particular embodiment. Annotations, such as comments regarding materials to be used, tolerances, and other notations, can also be included in a view.

Each drawing view can include one or more features, each feature having parameterized representations and unparameterized representations. Corresponding (or “matching”) representations can be logically or physically associated (or “attached”) to each other. For example, the modeling module 202 can make the appropriate associations and, for example, specify the mode or operation(s) by which the representations were created. In various embodiments, each representation is attached to each of the other representations. However, in some embodiments, one or more of the views or representations are not attached.

FIG. 3B illustrates an example modeling environment 300B (e.g., 3-D CAD environment) in accordance with one or more embodiments. The modeling environment 300B is represented by a user interface 302B. Within user interface 302B, a view 304B is shown. View 304B can be, for example, an interactive view of a 3-D representation of a part to be manufactured. In particular, in the embodiment shown in FIG. 3B, view 304B is 3-D view of a part having a conical shape. Additional or alternative views can be included, depending on the specific embodiment. In some embodiments, views of multiple parts to be fit together can each be represented within user interface 302B.

User interface 302B also includes a local coordinate system indicator 306B which is configured to enable the 3-D model to be oriented within the 3-D space. A user can manipulate the 3-D model, such as by causing the model to be rotated within the space, to view other sides or aspects of the model not visible in view 304B.

FIG. 4 depicts various example drawing views in an example modeling environment in accordance with one or more embodiments. The drawing view assembly depicted in FIG. 4 forms a cube. As described above, in various embodiments, 2-D drawing views are associated with corresponding surfaces (here, faces of the cube), and the cube bounds the object defined by the drawing views (400A-400F) in the modeling environment. In various embodiments, the modeling environment is an isometric modeling space, such that foreshortening is turned off. In other words, objects are viewed in isometric space in which the front face of a cube appears to be the same size as the rear face of the cube. The faces of the cube depicted in FIG. 4 are configured to at least partially contain, confine or section the 3-D model of the part. In other words, the 3-D model of the object is at least partially within the drawing view assembly. In various embodiments, the cube can be larger in size than the 3-D model and provides additional space around the 3-D model. The 2-D drawing views are associated with, or projected onto, surfaces of the cube in an orientation consistent with the 3-D model and the relations between the drawing views. Views need not be projected onto 2-D planes or faces in the traditional sense, but can be projected onto surfaces. These surfaces can by parametric, Bezier, non-uniform rational basis spline (NURBS), bicubic or other similar 3-D surface representations. These surfaces may be stand-alone independent objects at any orientation or one of a plurality of components that bound a volume.

For example, in FIG. 4A, cube 400A includes a front view 402A that is associated with a front face 404A of the cube (shaded for clarity). Within cube 400A, a 3-D model 406A of the part is oriented such that the “front” of the model 406A faces the front face 404A of the cube, the “top” of the model faces the top of the cube, etc. Similarly, in FIG. 4B, cube 400B includes a rear view 402B that is associated with a rear face 404B of the cube (shaded for clarity). In FIG. 4C, cube 400C includes a top view 402C that is associated with a top face 404C of the cube (shaded for clarity). Cube 400D (shown in FIG. 4D) includes a bottom view 402D that is associated with a bottom face 404D of the cube (shaded for clarity). In FIGS. 4B-D, the 3-D model has been removed for clarity, although in various embodiments, the 3-D model will be positioned within each of cubes 400B, 400C, and 400D as in FIG. 4A.

In FIG. 4E, cube 400E includes a left view 402E that is associated with a left face 404E of the cube (shaded for clarity). Within cube 400E, 3-D model 406E of the part is oriented such that the “left side” of the model 406E faces the left face 404E of the cube. Similarly, in FIG. 4F, cube 400F includes a right view 402F that is associated with a right face 404F of the cube (shaded for clarity). Within cube 400F, 3-D model 406F of the part is oriented such that the “right side” of the model 406F faces the right face 404F of the cube.

In various embodiments, one or more of the views (402A-F) can include design information such as drawing dimensions, notes, and other data corresponding to the part or object, as described above. In some embodiments, this additional information can be displayed or hidden, and controlled via a user, such as through a user's interaction with a check box or toggle switch displayed on the user interface, or other input means.

In various embodiments, means are provided to enable a user to cause a view of the model and associated drawings and models to be altered. For example, a user utilize a user interface or a user input device, such as a mouse, keyboard, or touchscreen, to zoom in or out on a view, rotate a view around one or more axes, or otherwise manipulate the view in order to view particular information. Additionally or alternatively, the user can select a particular drawing view and adjust the viewing angle of the 3-D model to align design information on the drawing view with the 3-D model in isometric space.

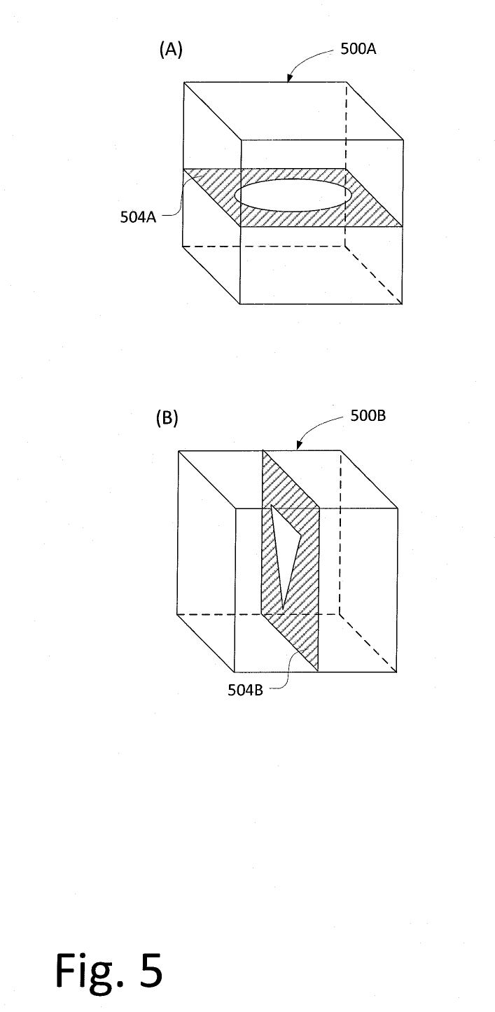

FIG. 5 illustrates example drawing views in an example modeling environment in accordance with one or more embodiments. The drawing view assembly depicted in FIG. 5 forms a cube with a number of internal planes. In particular, FIG. 5A illustrates cube 500A including a horizontal internal plane 504A (shaded for clarity). In various embodiments, a 2-D view of a part can be projected on horizontal internal plane 504A, similar to the projection of views on the outside faces of the cube. Likewise, FIG. 5B illustrates cube 500B including a vertical internal plane 504B (shaded for clarity). In various embodiments, a 2-D view of a part can be projected on vertical internal plane 504B. In some embodiments, various internal planes can be displayed within the cube, at various angles and positions within the cube. The 3-D model can also be included within the cube, as shown in FIG. 4. Similarly, in various embodiments, other views can additionally be projected on one or more faces of the cube. Additionally, multiple views can be projected onto a single face.

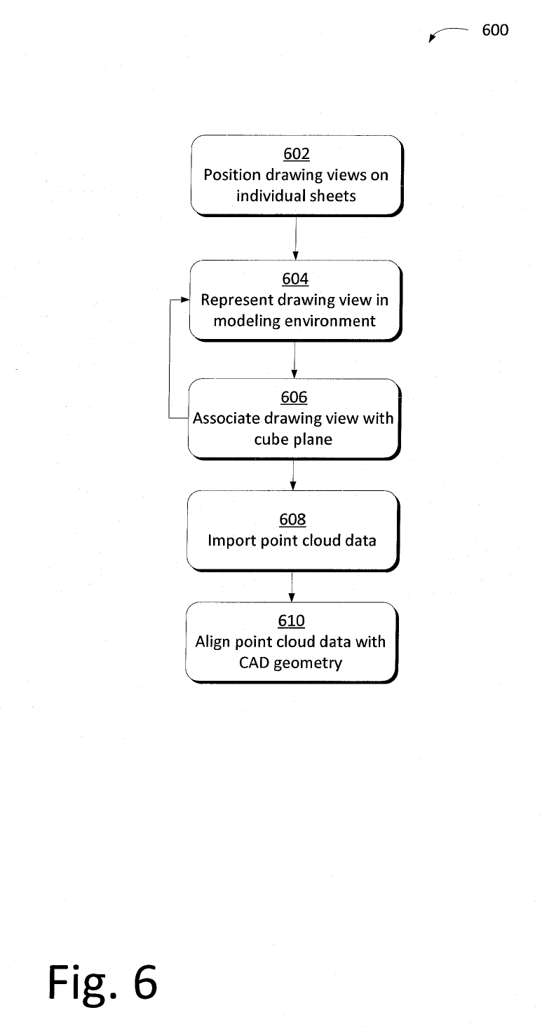

FIG. 6 is a flow diagram of an example method 600 for displaying 2-D drawings in a modeling environment within a CAD system. The method can be implemented in connection with any suitable hardware, software, firmware, or combination thereof. In at least some embodiments, the method can be implemented by a CAD executable module, such as CAD executable module 200.

Block 602 positions one or more drawing views on individual sheets in a drafting environment. This can be performed in any suitable way. For example, a user can create individual sheets within the drafting environment, each sheet being associated with one drawing view.

Next, block 604 enables the display of a 2-D drawing view in the 3-D modeling environment. This can be performed in any suitable way. For example, by interacting with application programming interface module 206, a user can configure the drafting module 304 to enable a drawing view to be exported as a 3-D part. In various embodiments, exporting the sheet to the modeling environment translates the drawing view into a 3-D representation of the various lines and arcs present in the drawing view. In some embodiments, exportation into the modeling environment can result in a loss of associativity between the drawing view and the 3-D model of the part. In other words, information that can be used to associate a drawing view with the corresponding portion of the 3-D model of the object is stripped during the translation from the drafting environment to the modeling environment. Therefore, in various embodiments, metadata associated with the drawing view can also be exported separately to enable the drawing view to be properly oriented and aligned in 3-D space consistent with relations among the drawing views.

Block 606 associates the drawing view displayed by block 604 with a surface in the drawing view assembly. The surface can be external to the object defined by the drawing view, and may bound a volume containing the object, or it can intersect the object defined by the drawing view. This association can be performed in any suitable way. For example, CAD executable module can apply a transformation matrix to associate each of the views and models with the drawing view assembly. The transformation matrix is an algorithm that fits (scales, positions, and orients) the CAD drawing or model coordinates to the 3-D coordinates. The transformation matrix is applied to relate the coordinates for the CAD model and drawings to the 3-D coordinates of the drawing view assembly. The particular transformation matrix can vary depending on the specific embodiment and the CAD system in which it is being applied. In various embodiments, the metadata associated with the drawing view is utilized to associate the drawing view with a corresponding surface in the drawing view assembly. For example, through the application programming interface module 206, the modeling module 202 can be configured to utilize the metadata to determine an orientation or scale for a drawing view in the modeling space.

In various embodiments, one or more drawing views can be associated with a layer in the modeling environment. A layer can be used to group objects in a logical way. In some embodiments, the CAD executable module may have a limited number of layers available for use. Therefore, in various embodiments, groups can be used, in addition to or as an alternative to layers, to combine components in the modeling environment. For example, components that make up a drawing view that is associated with the front face of a cube can be a first group or layer while components that make up a drawing view that is associated with the rear face of a cube can be a second group or layer. In various embodiments, the surface associated with a drawing view is included in the group or layer. In various embodiments, a 3-D model of the object can be included as a group or layer in the plurality of groups or layers.

In some embodiments, drawing views can be associated manually by a user with a corresponding surface in the drawing view assembly. For example, once the drawing views are exported from the drafting environment, a user can access each drawing view in the modeling environment and can create each group or layer without automated assistance from the CAD executable module. In other embodiments, the translation and association of the drawing views is conducted at least partially by the CAD executable module. In various embodiments, a user can adjust the initial placement and association of one or more views with a corresponding drawing view assembly surface.

In some embodiments, drawing views are exported from the drafting environment one at a time and associated with surfaces in the drawing view assembly. In such embodiments, the method can return to block 604 and export additional 2-D drawing views until each drawing view to be included in the environment has been exported to the modeling environment, associated with surfaces in the drawing view assembly, and properly aligned and oriented consistent with relations among the drawing views.

A user interface can be provided, such as through the API module, to enable users to turn groups or layers “on” or “off” or to change a view that is presented to a user. For example, the API module can be configured to enable to use information associated with each of the groups to determine a view that is normal to the view plane for that group. In this way, a user can interact with both the drawing views and the 3-D model.

Once the drawing views are associated with surfaces in the drawing view assembly, in various embodiments, block 608 imports point cloud data. This can be performed in any suitable way. For example, point cloud data representing a 3-D point cloud of an object can be obtained by scanning the object with a scanner and importing the data into the CAD executable module using manufacturing module 208. The scanner can be, for example, an optical or touch-probe scan, or other type of imaging device, depending on the particular embodiment. In some embodiments, a faceted surface representation of the object's surface topology is derived from the point cloud and can be used in place of or in addition to the point cloud.

Block 610 aligns the point cloud data with the CAD geometry. This can be performed in any suitable way. For example, manufacturing module 208 can provide an STL file corresponding to the point at block 608 and the data in the STL file can be associated with a layer or group that is aligned with the 3-D model of the object. In other words, the point cloud data can be overlaid on the 3-D model of the object to enable a user to visually or analytically compare an as-manufactured object (represented by the point cloud data) to the design intent (represented by the 3-D model and the drawing views).

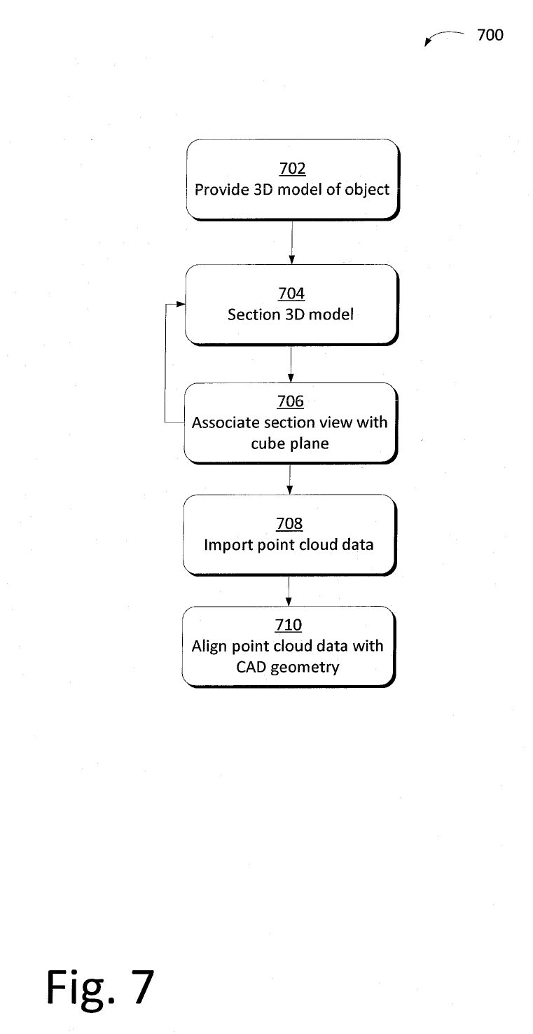

In various embodiments, drawing views can be created from the 3-D model rather than being exported from the drafting environment. FIG. 7 is a flow diagram of an example method 700 for extracting drawing views from a 3-D model in a modeling environment within a CAD system. The method can be implemented in connection with any suitable hardware, software, firmware, or combination thereof. In at least some embodiments, the method can be implemented by a CAD executable module, such as CAD executable module 200.

Block 702 provides a 3-D model of an object. This can be performed in any suitable way. For example, a user can build a 3-D model in the modeling environment by instantiating a representative view of a part, where the dimensions and location of each instance are stored in a table.

Next, block 704 sections the 3-D model. This can be performed in any suitable way. For example, by interacting with the application programming interface module 206, a user can cause the CAD executable module 200 to generate one or more dimensions for each section. In some embodiments, a section view can be a dimensioned version of the representative view from which the 3-D model was instantiated.

Block 706 associates the section view generated by block 704 with a surface in the drawing view assembly. The surface can be external to the object defined by the drawing view, and may bound a volume containing the object, or it can intersect the object defined by the drawing view. This association can be performed in any suitable way, examples of which are provided above and below. As above, multiple sections can be generated and associated with surfaces of the drawing view assembly by returning to block 704 until the desired sections have been generated.

Once the drawing views are associated with corresponding surfaces in the drawing view assembly, in various embodiments, block 708 imports point cloud data. This can be performed in any suitable way. For example, point cloud data representing a 3-D point cloud of an object can be obtained by scanning the object with a scanning device and importing the data into CAD executable module using manufacturing module 208. The scanning device can be, for example, an optical or touch-probe scanner, or other type of imaging device, depending on the particular embodiment. In various embodiments, one or more sets of data regarding spatial information corresponding to the object can be derived from the point cloud data and used to compare the manufactured object to the design intent for the object. Aligning the sets of data with the 3-D model of the object can also enable a user to identify how a set of data corresponds to the 3-D model.

Block 710 aligns the point cloud data with the CAD geometry. This can be performed in any suitable way. For example, manufacturing module 208 can provide an STL file corresponding to the point at block 708 and the data in the STL file can be associated with a layer or group that is aligned with the 3-D model of the object.

Having described various techniques for interacting with drawing views in a modeling environment, consider now the following example implementations of the techniques.

Assume that an engineer has created a 3-D model representing an airfoil for use in a turbine. The 3-D model can include information about the entire turbine, which includes a plurality of airfoils, some which have different sizes or shapes compared to others. The 3-D model can be used to create various 2-D drawing views that are used by a manufacturer to produce each airfoil according to the appropriate dimensions and within the appropriate tolerances.

Also assume that as the manufacturer produces each airfoil from the raw materials, it has a scanner in place. The scanner is configured to optically scan a selected number of airfoils produced by the manufacturer as a quality control measure. For example, every tenth airfoil can be scanned, every hundredth airfoil can be scanned, or each individual airfoil can be scanned depending on the manufacturing process and quality assurance requirements. The scan data can be sent to a system that includes a CAD executable module, such as CAD executable module 200.

In this example, CAD executable module 200 includes a drawing view assembly that was created according to the above-described techniques. Various surfaces are associated with the drawing views that correspond to the engineer's 3-D model, which were presumably utilized by the manufacturer to set the machines for manufacturing the part. The scan data, or point cloud data, is displayed within the modeling environment, aligned with the engineer's 3-D model. The manufacturer, by orienting the drawing view assembly, the nominally dimensioned 3-D model of the object, and the point cloud data normal to a given drawing view surface, can ascertain whether the point cloud data representing the actual, manufactured part, is consistent with the engineer's design intent. If there is an inconsistency, inspection in various orientations can enable the manufacturer to determine the true nature of the deviation (e.g., where and how much deviation there is), ascertain its root cause, and the manufacturing process can be adjusted. An inconsistency can be determined, for example, based on a comparison of a set of data derived from the manufactured object and a set of data derived from the design intent for the object. Consistency with the engineer's design intent can mean, for example, that the as-manufactured part will fit with adjacent or mating parts (e.g., the blade root will fit into the rotor). When an inconsistency is determined to exists, a design process or a manufacturing process can be adjusted. Then, a subsequently manufactured object can be scanned and a similar inspection performed to enable a user to determine that the inconsistency has been reduced or eliminated by comparing a set of data derived from the subsequently manufactured object with the set of data derived from the design intent for the object.

As another example, assume you are an engineer whose client has ordered a part to replace a worn part in a historical machine. As such, you have original manufacturing drawing views, but because of their age, not all of the information is legible. You also have the actual part that is to be replaced. You scan the part using an optical scanner and import the point cloud data into the 3-D modeling environment in which you have assembled a number of 2-D drawing views in relation to one another. Datum surfaces called out as lines and curves in various drawing views enable construction of those surfaces in 3-D space. Point cloud data can be aligned to those constructed datum surfaces. By examining the point cloud data from various views in line with the drawing views, you can determine where manufacturing changes were made following the creation of the original manufacturing drawings. You can alter the drawing views as needed and easily generate drawing views that can be used to create a matching replacement part. Accurate design information depicted in the drawing views can also be used to aid in the construction of fully geometric 3-D CAD models based on scans of the actual hardware.

### Example Device

FIG. 8 illustrates various components of an example device 800 that can be implemented as any type of portable and/or computer device as described with reference to FIG. 1. Device 800 includes communication devices 802 that enable wired and/or wireless communication of device data 804 (e.g., received data, data that is being received, data scheduled for broadcast, data packets of the data, etc.). The device data 804 or other device content can include configuration settings of the device, media content stored on the device, and/or information associated with a user of the device. Media content stored on device 800 can include any type of audio, video, and/or image data. Device 800 includes one or more data inputs 806 via which any type of data, media content, and/or inputs can be received, such as user-selectable inputs, messages, music, television media content, recorded video content, and any other type of audio, video, and/or image data received from any content and/or data source.

Device 800 also includes communication interfaces 808 that can be implemented as any one or more of a serial and/or parallel interface, a wireless interface, any type of network interface, a modem, and as any other type of communication interface. The communication interfaces 808 provide a connection and/or communication links between device 800 and a communication network by which other electronic, computing, and communication devices communicate data with device 800.

Device 800 includes one or more processors 810 (e.g., any of microprocessors, controllers, and the like) which process various computer-executable or readable instructions to control the operation of device 800 and to implement the embodiments described above. Alternatively or in addition, device 800 can be implemented with any one or combination of hardware, firmware, or fixed logic circuitry that is implemented in connection with processing and control circuits which are generally identified at 812. Although not shown, device 800 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 800 also includes computer-readable media 814, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 800 can also include storage media 816. The storage type computer-readable media are explicitly defined herein to exclude propagated data signals.

Computer-readable media 814 provides data storage mechanisms to store the device data 804, as well as various device applications 818 and any other types of information and/or data related to operational aspects of device 800. For example, an operating system 820 can be maintained as a computer application with the computer-readable media 814 and executed on processors 810. The device applications 818 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 818 also include any system components or modules to implement embodiments of the techniques described herein. In this example, the device applications 818 include an interface application 822 and a CAD executable module 824 are shown as software modules and/or computer applications. Alternatively or in addition, the interface application 822 and the CAD executable module 824 can be implemented as hardware, software, firmware, or any combination thereof.

Device 800 also includes an audio and/or video input-output system 826 that provides audio data to an audio system 828 and/or provides video data to a display system 830. The audio system 828 and/or the display system 830 can include any devices that process, display, and/or otherwise render audio, video, and image data. Video signals and audio signals can be communicated from device 800 to an audio device and/or to a display device via an RF (radio frequency) link, S-video link, composite video link, component video link, DVI (digital video interface), analog audio connection, or other similar communication link. In an embodiment, the audio system 828 and/or the display system 830 are implemented as external components to device 800. Alternatively, the audio system 828 and/or the display system 830 are implemented as integrated components of example device 800.

As before, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer-readable storage devices. The features of the techniques described above are platform-independent, meaning that the techniques may be implemented on a variety of commercial computing platforms having a variety of processors.

While various embodiments have been described above, it should be understood that they have been presented by way of example, and not limitation. It will be apparent to persons skilled in the relevant art(s) that various changes in form and detail can be made therein without departing from the scope of the present disclosure. Thus, embodiments should not be limited by any of the above-described exemplary embodiments, but should be defined only in accordance with the following claims and their equivalents.

What is claimed is:

1. A method comprising:
providing a plurality of two-dimensional (2-D) drawing views corresponding to a design intent for a three-dimensional (3-D) object, each drawing view in the plurality of drawing views being positioned on an individual drawing sheet;
displaying each 2-D drawing view in the plurality of drawing views in a 3-D modeling environment; and
associating each drawing view in the plurality of drawing views with a corresponding surface effective to generate a drawing view assembly; wherein the drawing view assembly comprises a plurality of surfaces in 3-D space having the plurality of drawing views projected thereon in an orientation consistent with relations between the plurality of drawing views and the 3-D object.

2. The method of claim 1, further comprising:
adjusting, based on received user input, a position of at least one drawing view in the plurality of drawing views with respect to its corresponding surface in the drawing view assembly.

3. The method of claim 1, further comprising:
grouping each drawing view in the plurality of drawing views and its corresponding surface in the drawing view assembly into one or more groups in a plurality of groups; and
altering a view displayed to a user by turning one or more groups in the plurality of groups on or turning one or more groups in the plurality of groups off.

4. The method of claim 1, further comprising:
providing a 3-D model of the object at least partially within the drawing view assembly in an orientation consistent with the relations among the plurality of drawing views.

5. The method of claim 4, further comprising:
providing a means for a user to select a particular drawing view from the plurality of drawing views and to adjust the viewing angle of the 3-D model effective to align the design information on the drawing view with the 3-D model in isometric space.

6. The method of claim 4, further comprising: importing one or more sets of data, the sets of data containing spatial information that corresponds to the 3-D model of the object at least partially within the drawing view assembly; and
aligning the sets of data with the 3-D model of the object at least partially within the drawing view assembly effective to enable a user to identify how the one or more sets of data correspond to the 3-D model.

7. The method of claim 4, further comprising:
importing point cloud data representing a surface topology of a manufactured object into the 3-D modeling environment; and
aligning the point cloud data with the 3-D model of the object at least partially within the drawing view assembly effective to enable a user to compare the manufactured object to the design intent for the object.

8. The method of claim 7, further comprising:
determining, based on a comparison of a set of data derived from the manufactured object and a set of data derived from the design intent for the object, that an inconsistency exists;
adjusting one or more of a design process and a manufacturing process; and
comparing a set of data derived from a subsequent manufactured object to the set of data derived from the design intent for the object effective to determine that the adjusting reduced or eliminated the inconsistency.

9. The method of claim 1, further comprising:
displaying design information corresponding to each drawing view.

10. The method of claim 9, wherein the design information comprises one or more of drawing dimensions, tolerances, notes, or comments regarding materials to be used to manufacture the object.

11. The method of claim 9, wherein the design information corresponding to each drawing view is represented in the 3-D modeling environment with each drawing view.

12. One or more computer-readable storage media comprising instructions that are executable to cause a device to perform a process comprising:
providing a 3-D model corresponding to an object in a 3-D modeling environment;
projecting the image of the 3-D model onto an external surface effective to generate a plurality of drawing views corresponding to the object;
sectioning the 3-D model with an intersecting surface effective to generate a plurality of drawing views corresponding to the object;
associating each drawing view in the plurality of drawing views with a corresponding surface in 3-D space effective to generate a drawing view assembly consistent with relations between the plurality of drawing views and the object that they define; and
providing the 3-D model of the object at least partially within the drawing view assembly in an orientation consistent with relations among the plurality of drawing views.

13. The one or more computer-readable storage media of claim 12, the process further comprising:
importing one or more sets of data, the sets of data comprising spatial information corresponding to the 3-D model of the object at least partially within the drawing view assembly; and
aligning the one or more sets of data with the 3-D model of the object at least partially within the drawing view assembly effective to enable a user to identify how a set of data in the one or more sets of data corresponds to the 3-D model.

14. The one or more computer-readable storage media of claim 12, the process further comprising:
scanning a manufactured object with a scanning device effective to generate point cloud data; importing point cloud data representing a surface topology of the manufactured object into the 3-D modeling environment; and
aligning the point cloud data with the 3-D model of the object at least partially within the drawing view assembly effective to enable a user to compare the manufactured object to a design intent for the object.

15. The one or more computer-readable storage media of claim 12, wherein providing a 3-D model comprises instantiating a representative view effective to generate the 3-D model of the object defined by the representative view.

16. The one or more computer-readable storage media of claim 15, further comprising:
displaying design information corresponding to the representative view, wherein the design information is stored in a table utilized to instantiate the representative view.

17. The one or more computer-readable storage media of claim 12, further comprising:
grouping each drawing view in the plurality of drawing views and its corresponding surface in the drawing view assembly into one or more groups in a plurality of groups; and
altering a view displayed to a user by turning one or more groups in the plurality of groups on or turning one or more groups in the plurality of groups off.

18. The one or more computer-readable storage media of claim 12, the process further comprising:
scanning a manufactured object with a scanning device effective to generate point cloud data;
importing point cloud data representing a surface topology of the manufactured object into the 3-D modeling environment;
aligning the point cloud data with the 3-D model of the object at least partially within the drawing view assembly effective to enable a user to compare the manufactured object to a design intent for the object, wherein the design intent for the object is represented by the plurality of drawing views; and
associating the point cloud data with a group in the plurality of groups effective to enable the point cloud data to be displayed to a user or hidden from a user.

19. A device comprising:
one or more processors;
one or more computer-readable storage media;
one or more modules embodied on the one or more computer-readable storage media and executable under the influence of the one or more processors, the one or more modules configured to:
provide a plurality of drawing views corresponding to an object and representing a view of the object;
display each drawing view in the plurality of drawing views in a 3-D modeling environment;
associating each drawing view in the plurality of drawing views with a corresponding surface effective to generate a drawing view assembly comprised of surfaces in 3-D space having the plurality of drawing views projected thereon in an orientation consistent with relations between the plurality of drawing views and the object that they define;
provide a 3-D model of the object at least partially within the drawing view assembly in an orientation consistent with the relations between the plurality of drawing views;
import point cloud data representing the surface topology of a manufactured object, or other data sets containing spatial information that corresponds to the 3-D model; and
align the point cloud data for a manufactured object, or other data sets containing spatial information that corresponds to the 3-D model, with the 3-D model of the object within or partially within the drawing view assembly, enabling a user to compare the manufactured object to the design intent for the object.

20. The device of claim 19, wherein the one or more modules are configured to associate each drawing view with a corresponding surface in the drawing view assembly by being configured to utilize metadata associated with each drawing view to associate each drawing view with the corresponding surface in the drawing view assembly.

21. The device of claim 20, wherein the one or more modules are further configured to:
adjust, based on received user input, a position of a drawing view with respect to the corresponding surface in the drawing view assembly.

22. The device of claim 19, wherein the one or more modules are further configured to:
group each drawing view in the plurality of drawing views and its corresponding surface in the drawing view assembly into one or more of a plurality of groups; and
alter a view displayed to a user by turning one or more groups in the plurality of groups on and turning one or more groups in the plurality of groups off.

23. The device of claim 19, wherein the one or more modules are further configured to:
display parametric data corresponding to each drawing view.

24. The device of claim 23, wherein the parametric data comprises one or more of drawing dimensions, tolerances, notes, or comments regarding materials to be used.

25. The device of claim 24, wherein the parametric data corresponding to each drawing view is displayed in the 3-D modeling environment with each drawing view.
